(19) United States
(12) Patent Application Publication
(10) Pub. No.: US 2007/0085804 A1
(43) Pub. Date: Apr. 19, 2007

(54) DRIVING CIRCUIT FOR ELECTRO-OPTICAL DEVICE AND ELECTRONIC APPARATUS

(75) Inventor: Kenichi TAJIRI, Azumino (JP)

Correspondence Address: HARNESS, DICKEY & PIERCE, P.L.C., P.O. BOX 828, BLOOMFIELD HILLS, MI, 48303, US

(73) Assignee: SANYO EPSON IMAGING DEVICES CORPORATION, Tokyo (JP)

(21) Appl. No.: 11/536,176

(22) Filed: Sep. 28, 2006

(30) Foreign Application Priority Data
Oct. 17, 2005 (JP) 2005-301254
Apr. 28, 2006 (JP) 2006-124919

(51) Int. Cl. G09G 3/36

(52) U.S. Cl. 345/98

(57) ABSTRACT

In a driving circuit for an electro-optical device in which a transmissive display mode and a reflective display mode can be switched, the driving circuit includes an image-processing circuit that converts image data for reflective display for the reflective display mode to image data for transmissive display for the transmissive display mode; and a control circuit that outputs the image data for the transmissive display converted by the image-processing circuit in the transmissive display mode, and stops driving the image-processing circuit to output the image data for the reflective display in the reflective display mode.

### BACKGROUND

1. Technical Field

The present invention relates to a driving circuit for an electro-optical device and an electronic apparatus. In particular, the invention relates to a driving circuit for an electro-optical device that can perform both transmissive display and reflective display, and an electronic apparatus including the driving circuit.

2. Related Art

Hitherto, liquid crystal display devices and other various electro-optical devices generally include a color filter so as to achieve color display. In the color filter, for example, one of a plurality of colored layers having different colors such as red, green, and blue is disposed on each of a plurality of pixels, and these colored layers having different colors are arrayed in a predetermined pattern. Such colored layers are formed by photolithography using a photosensitive resin containing a coloring material such as a pigment or a dye.

In a known display device, in a relatively dark environment, for example, indoors or in a car, transmissive display is realized in which images are visible with light emitted from a backlight disposed at the rear of the electro-optical device, and in a bright environment, such as outdoors, reflective display is realized in which the backlight is turned off and images are visible with outside light In such a device, a light-transmitting area through which light is transmitted and a light-reflecting area in which light is reflected are provided in each pixel. The transmissive display is realized using the light-transmitting area and the reflective display is realized using the light-reflecting area (see, for example, JP-A-2002-258029).

However, the above known technique discloses no method of driving the device in which the color reproduction property is satisfactorily achieved and power consumption is reduced in the case of realizing both the transmissive display and the reflective display in the electro-optical device.

### SUMMARY

An advantage of the invention is that it provides a driving circuit for an electro-optical device that realizes driving in which the color reproduction property can be satisfactorily achieved and power consumption can be reduced.

According to a first aspect of the invention, in a driving circuit for an electro-optical device in which a transmissive display mode and a reflective display mode can be switched, the driving circuit includes an image-processing circuit that converts image data for reflective display for the reflective display mode to image data for transmissive display for the transmissive display mode; and a control circuit that outputs the image data for the transmissive display converted by the image-processing circuit in the transmissive display mode, and stops driving the image-processing circuit to output the image data for the reflective display in the reflective display mode.

In the driving circuit for an electro-optical device according to the first aspect of the invention, in the reflective display mode, the control circuit preferably stops driving the image-processing circuit by stopping the supply of a clock signal to the image-processing circuit. This structure can provide a driving circuit for an electro-optical device that can realize driving in which the color reproduction property can be satisfactorily achieved and power consumption can be reduced.

In the driving circuit for an electro-optical device according to the first aspect of the invention, preferably, the driving circuit further includes an amplifier that amplifies the image data for the transmissive display and the image data for the reflective display, and a selective output circuit that selects either the image data for the reflective display or the image data for the transmissive display within a predetermined period to output the image data. In this case, in the reflective display mode, the control circuit preferably controls the amplification factor of the amplifier that amplifies the image data for the reflective display so as to be lower than the amplification factor in the transmissive display mode. In addition, in the reflective display mode, the selective output circuit preferably selects the color signals having the three hues and dummy data to output the signals and the data According to this structure, in the reflective mode, the amplifier amplifies the image data at an amplification factor lower than that in the transmissive mode. Therefore, power consumption of the driving circuit of the liquid display device can be further reduced.

In the driving circuit for an electro-optical device according to the first aspect of the invention, the image data for the reflective display are preferably color signals having three hues of a red tone, a green tone, and a blue tone, and the image data for the transmissive display are preferably color signals having four or more hues. Preferably, the driving circuit for an electro-optical device further includes a select timing control circuit that controls the output of the selective output circuit. In this case, in the transmissive display mode and the reflective display mode, the select timing control circuit preferably controls the output of the selective output circuit so that the selection period of each image data is different for the color signals having the three hues and for the color signals having the four or more hues. The select timing control circuit preferably controls the output of the selective output circuit so that, during one horizontal scanning period, the period during which each image data is selected in the reflective display mode is longer than the period during which each image data is selected in the transmissive display mode. According to this structure, the color reproduction property can be further improved, and, in the reflective mode, the amplifier amplifies the image data at an amplification factor lower than that in the transmissive mode. Thus, power consumption of the driving circuit of the liquid display device can be further reduced.

In the driving circuit for an electro-optical device according to the first aspect of the invention, the image-processing circuit preferably converts the image data for the reflective display of the color signals having the three hues to the image data for the transmissive display of the color signals having the four or more hues. According to this structure, since such a conversion circuit is used only in the transmissive mode, power consumption of the driving circuit can be reduced.

An electronic apparatus according to a second aspect of the invention includes the driving circuit for an electro-optical device according to the first aspect of the invention. This structure can realize an electronic apparatus having low power consumption.

### BRIEF DESCRIPTION OF THE DRAWINGS

The invention will be described with reference to the accompanying drawings, wherein like numbers reference like elements.

FIG. 1 is an enlarged perspective plan view showing an inner structure of a display unit (pixel) according to a first embodiment of the invention.

FIG. 2 is an enlarged longitudinal cross-sectional view showing a cross-sectional structure of one pixel.

FIG. 3 is an x-y chromaticity diagram showing a color reproduction range realized with a color filter.

FIG. 4 is a block diagram showing a driving circuit according to the first embodiment.

FIG. 5 is a block diagram showing a driving circuit according to a second embodiment.

FIG. 6 is a timing chart of each image data during one horizontal scanning period in a transmissive mode.

FIG. 7 is a timing chart of each image data during one horizontal scanning period in a reflective mode.

FIG. 8 is a perspective view of a cell phone as an example of an electronic apparatus.

### DESCRIPTION OF EXEMPLARY EMBODIMENTS

Embodiments of the invention will now be described with reference to the attached drawings.

### First Embodiment

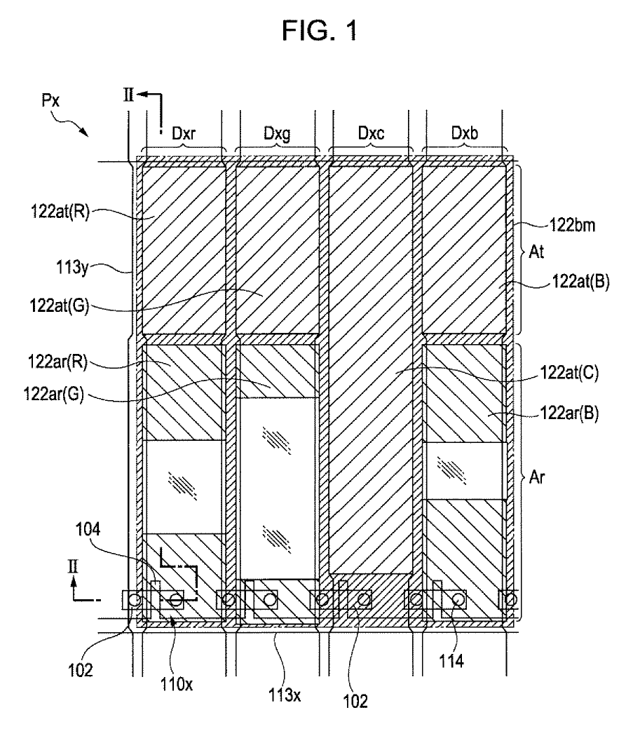

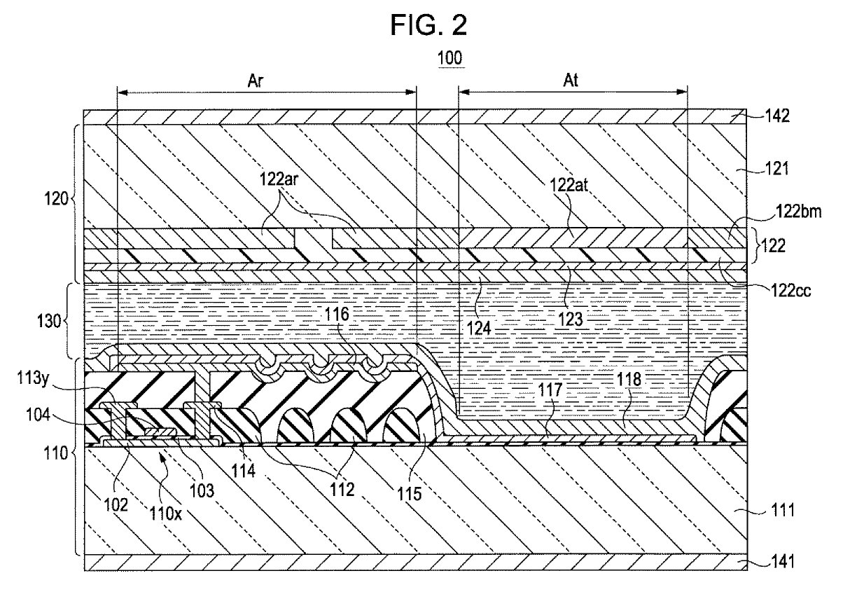

First, the structure of an electro-optical device according to a first embodiment of the invention will be described on the basis of FIGS. 1 and 2. FIG. 1 is an enlarged perspective plan view showing an inner structure of a display unit (pixel) of a pixel array of an electro-optical device according to this embodiment. FIG. 2 is an enlarged longitudinal cross-sectional view showing a cross-sectional structure of one pixel in the electro-optical device.

This embodiment shows a liquid crystal device, which is an example of electro-optical devices. As shown in FIG. 2, bases 110 and 120 are bonded with a sealing material (not shown in the figure) therebetween so as to have a predetermined distance. A liquid crystal layer 130 is disposed between the bases 110 and 120.

The base 110 includes a transparent substrate 111 composed of a glass, a plastic, or the like. A TFT (switching element) 110X is provided on the inner surface of the substrate 111. The TFT 110X includes a semiconductor layer 102 composed of a polysilicon layer or the like, a gate insulating film 103 provided on the semiconductor layer 102, and a gate electrode 104 facing a channel region of the semiconductor layer 102 with the gate insulating film 103 therebetween. The gate electrode 104 is electrically connected to a scanning line 113x shown in FIG. 1.

An interlayer insulation film 112 composed of silicon oxide or the like is formed on the above structure. The interlayer insulation film 112 is formed by photolithography or the like so as to cover the TFT 110X and to provide fine irregularities on the surface. A data line 113y that is electrically connected to a source region of the semiconductor layer 102 and a connecting electrode 114 that is electrically connected to a drain region of the semiconductor layer 102 are provided on the interlayer insulation film 112.

An interlayer insulation film 115 composed of silicon oxide or the like is provided on the above structure. A reflective layer 116 composed of a metal such as aluminum or another reflective conductor is provided on the interlayer insulation film 115. The reflective layer 116 is electrically connected to the connecting electrode 114. The reflective layer 116 includes a scattering reflective surface having a fine irregular structure, which reflects the surface irregular shape of the interlayer insulation film 112. The reflective layer 116 is provided in the form of islands in one subpixel so as to correspond with a light-reflecting area Ar provided in the subpixel. In addition to the light-reflecting area Ar, a light-transmitting area At is provided in the subpixel. The reflective layer 116 is not provided in the light-transmitting area At.

An electrode 117 composed of a transparent conductor such as indium tin oxide (ITO) is provided on the reflective layer 116. The electrode 117 is provided over the entire display area in the subpixel, that is, so as to cover all the area including both the light-transmitting area At and the light-reflecting area Ar. The electrode 117 is electrically connected to the drain region of the TFT 110X, with the reflective layer 116 therebetween. In this embodiment, since the reflective layer 116 functions as a reflective electrode, the electrode 117 serving as a transparent electrode need not be provided on the area covering the entirety of the reflective layer 116 (light-reflecting area). A part of the electrode 117 serving as the transparent electrode may be laminated with the reflective layer 116 so as to establish an electrical connection.

An alignment layer 118 composed of a polyimide resin or the like is provided on the above structure. This alignment layer 118 is used for providing liquid crystal molecules in the liquid crystal layer 130 with an initial orientation. The alignment layer 118 is formed by, for example, applying an uncured resin, curing the resin by baking or the like, and performing a rubbing treatment or the like.

On the other hand, the base 120 includes a transparent substrate 121 composed of a glass, a plastic, or the like. A color filter 122 is provided on the inner surface of the substrate 121. The color filter 122 includes a colored layer 122at provided in the light-transmitting area At and a colored layer 122ar provided in the light-reflecting area Ar. These colored layers 122at and 122ar have one color selected from red, green, and blue, which are filter colors in a primary color system described below. The colored layer 122at and the colored layer 122ar that are disposed in the same subpixel fundamentally have the same color. Alternatively, these colored layers 122at and 122ar may have different hues (color concentration, chromaticity, or chroma) or different light transmittances. In this embodiment, the colored layers 122at and 122ar that are disposed in the same subpixel are simultaneously formed using the same coloring material and have the same hue and the same light transmittance.

The color filter 122 includes a light-shielding layer 122bm composed of a black resin or the like. The light-shielding layer 122bm is provided between subpixels, between pixels, and between the light-transmitting area At and the light-reflecting area Ar. The light-shielding layer 122bm shields light in areas where a desired oriented state of liquid crystal molecules is not achieved because of, for example, an oblique electric field generated at edges of the electrode 117 and an electrode 123 described below that is adjacent to the base 120 or surface irregularities of the base 110 or 120. Thereby, a decrease in the contrast caused by light leakage or the like is prevented.

Furthermore, a protective film 120cc composed of an acrylic resin or the like is provided on the colored layers 122at and 122ar and the light-shielding layer 122bm. This protective film 120cc planarizes the surface of the color filter 122 and prevents the degradation of the colored layers 122at and 122ar caused by intrusion of impurities.

The electrode 123 composed of a transparent conductor such as ITO is provided on the color filter 122. An alignment layer 124, which is similar to the above alignment layer 118, is provided on the electrode 123. Since the TFT 110X, which is a three-terminal switching element (nonlinear element), is used in this embodiment, the electrode 117 is a pixel electrode that is independent in each subpixel, and the electrode 123 is a common electrode provided over a plurality of subpixels (and a plurality of pixels) (preferably over the entire device). However, when a two-terminal switching element (nonlinear element) is used instead of the TFT 110X, the electrode 123 facing the electrode 117 is constituted by a plurality of strip electrodes that extend in a direction intersecting the data line 113y and that are arrayed in the extending direction of the data line 113y in a stripe formation.

The liquid crystal layer 130 is a liquid crystal layer of the TN mode or the STN mode formed of a nematic liquid crystal or the like. The liquid crystal layer 130 cooperates with polarizers 141 and 142 disposed outside the bases 110 and 120, respectively, to control the light transmittance of each subpixel. In this embodiment, the thickness of the liquid crystal layer 130 in the light-transmitting area At is set so as to be larger than (for example, about 2 times) the thickness of the liquid crystal layer 130 in the light-reflecting area Ar. This structure does not cause a significant difference between the degree of optical modulation of the liquid crystal layer 130 in the transmissive display using the light-transmitting area At and the degree of optical modulation of the liquid crystal layer 130 in the reflective display using the light-reflecting area Ar.

In this embodiment, the presence or absence of the interlayer insulation films 112 and 115 causes the difference between the thickness of the liquid crystal layer 130 in the light-transmitting area At and the thickness of the liquid crystal layer 130 in the light-reflecting area Ar. Alternatively, for example, an insulating film may be provided on the color filter 122, and the presence or absence of this insulating film may cause the difference in the thickness of the liquid crystal layer 130 between the light-transmitting area At and the light-reflecting area Ar.

In this embodiment, a pixel Px shown in FIG. 1 is a base unit constituting the minimum unit of a display image. The pixel Px has a rectangular planar shape and is composed of four types of subpixel Dxr, Dxg, Dxc, and Dxb. Each of the subpixels in this specification is the minimum control unit in which the light transmittance thereof can be independently controlled, and a plurality of such subpixels constitute the pixel Px. Accordingly, the number of subpixels forming the pixel Px is not generally limited to four. In this embodiment, the number of subpixels forming the pixel Px is an arbitrary number of four or more.

The pixel structure shown in FIG. 2 shows the structure of three types of subpixel Dxr, Dxg, and Dxb among the above four types of subpixel and corresponds to the colored layers of three filter colors R (red tone), C (green tone), and B (blue tone). As described above, each structure of these three types of subpixel includes the light-transmitting area At and the light-reflecting area Ar. A feature common to the structures is that the colored layers 122at and 122ar of R (red tone) G (green tone), or B (blue tone) are provided at the areas At and Ar of each of the three types of subpixel. In these three types of subpixel Dxr, Dxg, and Dxb, the area ratios of the light-transmitting area At to the light-reflecting area Ar are substantially the same.

In these three types of subpixel Dxr, Dxg, and Dxb, the colored layer 122at is provided over the light-transmitting area At. That is, the light-transmitting area At of each of the three types of subpixel is covered with a colored layer of R (red tone), G (green tone), or B (blue tone). On the other hand, in the example shown in the figure, the colored layer 122ar is selectively provided on a part of the light-reflecting area Ar. That is, a non-colored area in which light is reflected without being colored on the reflective layer 116 is provided on the light-reflecting area Ar. In addition, the subpixels Dxr, Dxg, and Dxb are formed such that the area ratio of the colored layer 122ar in the light-reflecting area Ar is different between the subpixels Dxr, Dxg, and Dxb. However, in at least one of the light-reflecting areas Ar of the three types of subpixel, the colored layer 122ar may be formed so as to entirely cover the light-reflecting area Ar.

On the other hand, unlike the three types of subpixel Dxr, Dxg, and Dxb, only the light-transmitting area At is substantially provided in the subpixel Dxc. In addition, the area of this light-transmitting area At is larger than the area of the light-transmitting area At of the other three types of subpixel. In the above description, the subpixels are expressed as the subpixels of red tone, green tone, and blue tone, but four colored areas including the colored layer 122at of the light-transmitting area At of the subpixel Dxc will now be described in detail.

When four colored areas form a single pixel, among the visible light region (380 to 780 nm) in which the hue is changed according to the wavelength, the four colored areas are composed of a colored area of a hue of blue tone, a colored area of a hue of red tone, and colored areas of two types of hue selected from hues in the range of blue to yellow. Here, regarding the term “tone”, for example, in the blue tone, the hue is not limited to a pure blue hue. The blue tone also includes bluish purple, blue-green, and the like. The hue of the red tone includes not only red but also orange. Furthermore, the colored area may be composed of a single colored layer or formed by laminating a plurality of colored layers having different hues. The colored areas are described in terms of hue, but the hue represents a parameter that can be set for a color by appropriately changing chroma and brightness.

The specific range of the hue is as follows. The colored area of the hue of blue tone is from bluish purple to blue-green, and more preferably from indigo blue to blue. The colored area of the hue of red tone is from orange to red. One of the colored areas selected from hues in the range of blue to yellow is from blue to green, and more preferably from blue-green to green. Another colored area selected from hues in the range of blue to yellow is from green to orange, and more preferably from green to yellow or from green to yellow-green. Each colored area does not have the same hue. For example, when a hue of green tone is used in one of the two colored areas selected from hues in the range of blue to yellow, a hue of blue tone or a hue of yellow-green tone is used as the other colored area. Thereby, a wide range of colors can be reproduced compared with known RGB colored areas.

This wide range of colors has been described in terms of hue, the colored areas will be expressed in terms of wavelength of light transmitted through the colored areas. The colored area of the blue tone is a colored area in which the peak of the wavelength thereof lies in the range of 415 to 500 nm, and preferably in the range of 435 to 485 nm. The colored area of the red tone is a colored area in which the peak of the wavelength thereof lies at 600 nm or longer, and preferably 605 nm or longer. One of the colored areas selected from hues in the range of blue to yellow is a colored area in which the peak of the wavelength thereof lies in the range of 485 to 535 nm, and preferably in the range of 495 to 520 nm. Another colored area selected from hues in the range of blue to yellow is a colored area in which the peak of the wavelength thereof lies in the range of 500 to 590 nm, and preferably in the range of 510 to 585 nm or in the range of 530 to 565 nm. In the case of the transmissive display, these wavelengths represent numeric values obtained by transmitting light emitted from a lighting system through a color filter. In the case of the reflective display, these wavelengths represent numeric values obtained by reflecting outside light.

Next, the colored areas will be expressed in terms of an x-y chromaticity diagram. The colored area of the blue tone lies in the range of x≦0.151, and y≦0.200, and preferably in the range of 0.134≦×≦0.151, and 0.034≦y ≦0.200. The colored area of the red tone lies in the range of 0.520≦x, and y≦0.360, and preferably in the range of 0.550≦×≦0.690, and 0.210≦y≦0.360. One of the colored areas selected from hues in the range of blue to yellow lies in the range of x≦0.200, and 0.210≦y, and preferably in the range of 0.080≦×≦0.200, and 0.210≦y ≦0.759. Another colored area selected from hues in the range of blue to yellow lies in the range of 0.257≦×, and 0.450≦y, and preferably in the range of 0.257≦×≦0,520, and 0.450≦y≦0.720. In the case of the transmissive display, these values in the x-y chromaticity diagram represent numeric values obtained by transmitting light emitted from a lighting system through a color filter. In the case of the reflective display, these values in the x-y chromaticity diagram represent numeric values obtained by reflecting outside light. When a subpixel includes a transmitting area and a reflecting area, the above-described ranges of the four colored areas can be applied to both the transmitting area and the reflecting area. A light-emitting diode (LED) as a light source of RGB, a fluorescent tube, or an organic electroluminescence (EL) may be used as the backlight. Alternatively, a white light source may be used. The white light source may be formed by a blue illuminant and a YAG phosphor.

The following are preferred as the RGB light source. The light source of B preferably has a wavelength peak in the range of 435 to 485 nm. The light source of G preferably has a wavelength peak in the range of 520 to 545 nm. The light source of R preferably has a wavelength peak in the range of 610 to 650 nm. When the color filter (CF) is appropriately selected according to the wavelengths of the RGB light source, color reproduction over a wider range of colors can be obtained. A light source having a plurality of wavelength peaks, for example, at 450 and 565 nm, may also be used.

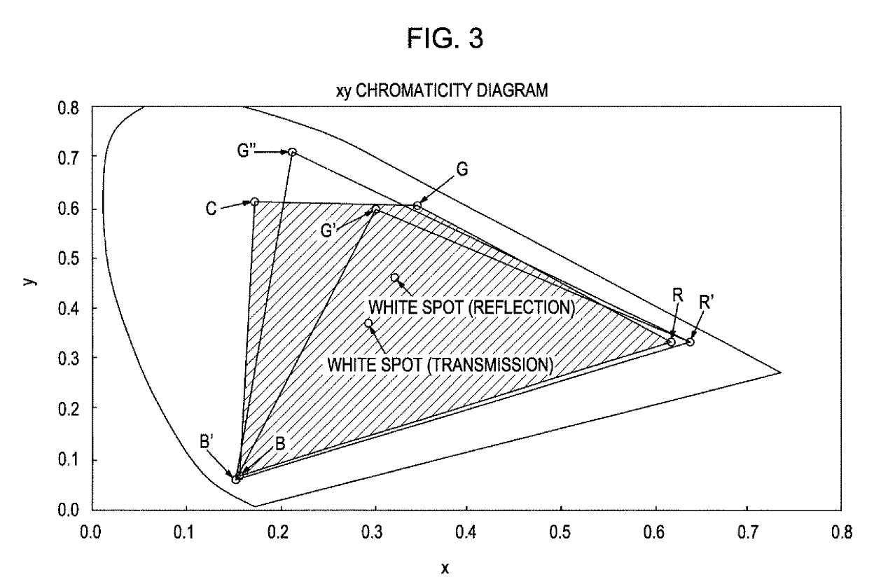

Examples of the combination of the four colored areas include colored areas having hues of red, blue, green, and cyan (blue-green); colored areas having hues of red, blue, green, and yellow; colored areas having hues of red, blue, dark green, and yellow; colored areas having hues of red, blue, emerald, and yellow; colored areas having hues of red, blue, dark green, and yellow-green; and colored areas having hues of red, blue-green, dark green, and yellow-green. FIG. 3 is an x-y chromaticity diagram showing a color reproduction range realized with the color filter 122 used in this embodiment. Points R′, G′, and B′ in the figure show hues suitable as the colored layers of red, green, and blue disposed in the light-reflecting area Ar. Point G″ in the figure shows a hue suitable as the colored layer of green disposed in the light-transmitting area At. Furthermore, the curve surrounding the above points shows the range of hues that can be perceived by a human.

Referring to the chromaticity diagram, the area of a color quadrangle surrounded by points R, G, B, and C of this embodiment is larger than the area of a color triangle formed by vertices R′, G′, and B′. This indicates that the color reproduction range of the transmissive display of this embodiment is wider than the color reproduction range of the reflective display. When the transmissive display is performed with a filter structure of three known primary colors, as shown by the color triangle formed by points R′, G″, and B′, a wide color reproduction range is provided to some extent. The chromaticity diagram shows that the color reproduction range shown by points R, G, B, and C of this embodiment can be the same as or wider than the color reproduction range of the above case. In this embodiment, the colored layer 122at provided in the light-transmitting area At and the colored layer 122ar provided in the light-reflecting area Ar are simultaneously formed using the same material, thereby suppressing an increase in the production cost and further improving the color reproduction property in the transmissive display. Furthermore, in order to more satisfactorily ensure brightness in the reflective display, a colored layer having a relatively high chroma is provided on the entirety of the light-transmitting area At, whereas the same colored layer is partially (selectively) provided on the light-reflecting area Ar. That is, the light-reflecting area Ar includes an area where the colored layer is not provided to expose the reflective layer 116. According to this structure, even when the chroma of the colored layer does not markedly decrease, the same effect as in the case where the chroma of the colored layer 122ar decreases can be achieved in the whole light-reflecting area Ar. However, in at least one of the three types of subpixel, the colored layer 122ar may be formed so as to entirely cover the light-reflecting area Ar.

Furthermore, in this embodiment, since all the subpixels constituting one pixel have the same area, the light-transmitting area At of the subpixel Dxc can be larger than the light-transmitting areas At of the other three types of subpixel Dxr, Dxg, and Dxb. As a result, the opening ratio in the transmissive display can be substantially increased compared with a known structure, thereby increasing the luminance of the transmissive display and further improving the display quality. In particular, when only the light-transmitting area At is substantially provided in the subpixel Dxc as in this embodiment, that is, when the reflective layer 116 is not provided in the subpixel Dxc and the entire area of the subpixel forms the light-transmitting area, the area of the light-transmitting area At of the subpixel Dxc can be maximized. Therefore, the above effects can be further increased.

As described above, in this embodiment, the colored area of red tone, the colored area of blue tone, one colored area selected from hues in the range of blue to yellow, and another colored area selected from hues in the range of blue to yellow are used as the filter colors that are set only in the transmissive display. Thereby, in particular, color reproduction of the hue area of green tone can be obtained over a wider range. The structure shown in FIGS. 1 and 2 is an example and various modifications can be made to the structure of each pixel.

The liquid crystal device composed of a plurality of pixels each having the above-described structure can perform both the transmissive display and the reflective display. Such a liquid crystal device is installed in an electronic apparatus such as a cell phone and is used as a display device.

For example, when a cell phone equipped with the liquid crystal device is used in a dark place, for example, indoors, the cell phone is used in a transmissive mode in which a backlight is turned on. When the cell phone is used in a bright environment, for example, outdoors, the cell phone is used in a reflective mode in which the backlight is not turned on. The visibility of images of the liquid crystal device for users is different depending on the ambient brightness. Accordingly, in a bright environment, the liquid crystal device is used in the reflective mode without turning on the backlight. Therefore, image data for the reflective display of three colors, i.e., RGB (red tone, green tone, and blue tone) are used. In contrast, in a dark environment, the liquid crystal device is used in the transmissive mode while the backlight is turned on. Therefore, image data for the transmissive display of the above-described four colors are used.

The determination of which display mode of the transmissive mode or the reflective mode is used is performed as one of the main functions of the electronic apparatus such as a cell phone. Driving circuits are driven on the basis of information of the selected display mode. The determination of the display mode is performed as follows. For example, the ambient brightness may be detected with a light sensor provided in the cell phone, and a display mode determination unit may be provided in the cell phone. When the ambient brightness is equal to or lower than a predetermined brightness, the display mode determination unit selects the transmissive mode as the display mode. Alternatively, a switch for manually turning on or off a backlight may be provided in the cell phone, and the display mode may be determined on the basis of the selective state of the switch.

During the transmissive mode, the backlight is turned on, whereas during the reflective mode, the backlight is turned off. The determination of whether the transmissive mode or the reflective mode may be performed by the display mode determination unit or with reference to the output of the switch as described above. Alternatively, the determination may be performed with reference to the state of the backlight, that is, by referring to whether the backlight is in the on state or off state. A signal MODE showing the display mode is supplied to a driving circuit described below.

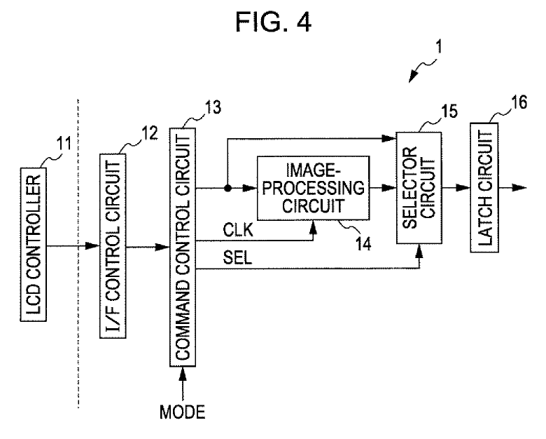

Next, a description will be made of the driving circuit for realizing both the reflective display and the transmissive display in the liquid crystal device which has the pixel structure shown in FIG. 1 and in which a plurality of pixels are arrayed in a matrix. FIG. 4 is a block diagram showing the driving circuit according to this embodiment.

A driving circuit 1 for a liquid crystal device (hereinafter simply referred to as driving circuit 1) is one of a plurality of driving circuits of a liquid crystal panel including the above-described liquid crystal device and receives image data and various command signals output from an LCD controller 11, which is an external device. The driving circuit 1 includes an interface control circuit 12 (hereinafter referred to as I/F control circuit 12), a command control circuit 13, an image-processing circuit 14, a selector circuit 15, and a latch circuit 16.

Image data and the like from the LCD controller 11 are input to the I/F control circuit 12 The I/F control circuit 12 outputs the input image data and the like at every predetermined unit, for example at every 8 bits, to the command control circuit 13.

The command control circuit 13 outputs the image data and a control signal to the image-processing circuit 14 and the selector circuit 15, according to whether the input signal is a command signal or the image data. The image data is output to the image-processing circuit 14 at every predetermined unit and at a predetermined timing. For example, the command control circuit 13 outputs the image data to the image-processing circuit 14 at a unit of 24 bits at every one clock (CLK).

Furthermore, the command control circuit 13 supplies a clock signal (CLK) to the image-processing circuit 14 or stops the supply of the clock signal (CLK) to the image-processing circuit 14 according to the display mode, that is, according to whether the display mode is the reflective mode or the transmissive mode. Specifically, when the display mode is the transmissive mode, the command control circuit 13 supplies the image-processing circuit 14 with the clock signal (CLK) When the display mode is the reflective mode, the command control circuit 13 stops supplying the image-processing circuit 14 with the clock signal (CLK). The signal MODE showing the display mode is input to the command control circuit 13.

The image-processing circuit 14 includes a color conversion circuit that converts three image signals of three colors, i.e., RGB (red tone, green tone, and blue tone) into image signals of four colors described above. As described below, during the reflective mode, since the clock signal (CLK) is not input to the image-processing circuit 14, the image-processing circuit 14 stops the driving operation.

Image data output from the command control circuit 13 and image data output from the image-processing circuit 14 are input to the selector circuit 15. The selector circuit 15 selects either the image data output from the command control circuit 13 or the image data output from the image-processing circuit 14 on the basis of a selection signal (SEL) supplied from the command control circuit 13 and outputs the selected image data.

The selector circuit 15 outputs the selected image data at a predetermined unit to the latch circuit 16 such as a random access memory (RAM). The image data stored in the latch circuit 16 is written in predetermined pixels of the liquid crystal device by another driving circuit (not shown). As a result, a desired image is displayed on the display area of the liquid crystal device. During the reflective mode, dummy data is written in the latch circuit 16 by the selector circuit 15 as image data of cyan, which is one of the color signals. The command control circuit 13 and the selector circuit 15 constitute a control circuit in which, in the case of the transmissive display, image data for the transmissive display that is converted by the image-processing circuit 14 is output, and in the case of reflective display, the driving of the image-processing circuit 14 is stopped to output image data for the reflective display.

The operation of the driving circuit having the above structure will now be described. The command control circuit 13 operates according to the information MODE of the input display mode. When the display mode is the transmissive mode, the command control circuit 13 supplies the image-processing circuit 14 with the clock signal (CLK) and outputs to the selector circuit 15 a selection signal (SEL) for selecting image data output from the image-processing circuit 14 and outputting the selected image data to the latch circuit 16.

When the display mode is the reflective mode, the command control circuit 13 stops supplying the image-processing circuit 14 with the clock signal (CLK), and the process for converting from three colors to four colors is not performed. Furthermore, during the reflective mode, the command control circuit 13 outputs to the selector circuit 15 a selection signal (SEL) for selecting the image data output from the command control circuit 13 and outputting the selected image data. As a result, during the reflective mode, since the clock signal (CLK) is not input to the image-processing circuit 14, the image-processing circuit 14 is not driven, and thus electric power is not consumed.

Consequently, according to this embodiment, since the image-processing circuit 14 is not driven during the reflective mode, power consumption of the driving circuit for the liquid crystal device can be reduced.

### Second Embodiment

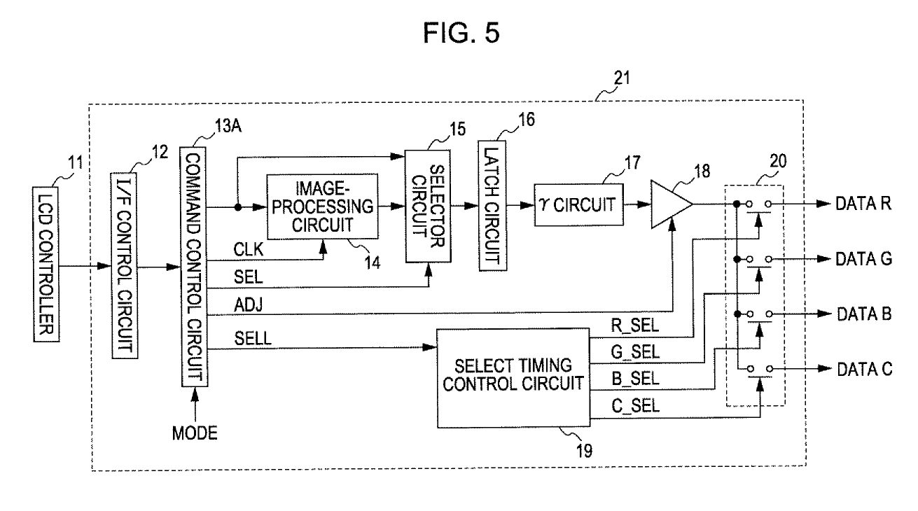

FIG. 5 is a block diagram showing a driving circuit according to a second embodiment of the invention. A driving circuit 21 for a liquid crystal device (hereinafter simply referred to as driving circuit 21) is one of a plurality of driving circuits of the liquid crystal panel including the liquid crystal device described in the first embodiment and receives image data and various command signals output from the LCD controller 11, which is an external device, as in the first embodiment. In the second embodiment, the same components as those in the first embodiment are assigned the same reference numerals, and the description of those components is omitted.

In the driving circuit according to the second embodiment, the amplification factor of an amplifying circuit for amplifying various image data is changed according to the transmissive mode or the reflective mode, thereby further reducing power consumption.

The driving circuit 21 includes not only the I/F control circuit 12, a command control circuit 13A, the image-processing circuit 14, the selector circuit 15, and latch circuit 16, but also a gamma (γ) correction circuit 17 (hereinafter referred to as gamma circuit 17), an amplifier 18, a select timing control circuit 19, and a signal selection circuit 20.

The gamma circuit 17 is a circuit for gamma correction. The gamma circuit 17 performs gamma correction on image data and supplies the amplifier 18 with the gamma-corrected image data. The amplifier 18 is an amplifying circuit for amplifying the image data by a predetermined amplification factor. The amplifier 18 amplifies the image data supplied from the gamma circuit 17 by a predetermined amplification factor and supplies the amplified data to the signal selection circuit 20. As described below, the amplification factor of the amplifier 18 is determined by an amplification factor control signal (ADJ) supplied from the command control circuit 13A.

The select timing control circuit 19 outputs a selection signal of each image data to the signal selection circuit 20 on the basis of a selection control signal (SELL) supplied from the command control circuit 13A in order that the signal selection circuit 20 selects the image data input to the signal selection circuit 20 and outputs the selected image data.

The signal selection circuit 20 includes switching circuits that select a plurality of input image data. The signal selection circuit 20 selects image data for the transmissive display and image data for the reflective display that are input at a predetermined timing according to the display mode. In this case, the signal selection circuit 20 selects the image data at a predetermined timing and for a predetermined period on the basis of the selection signals supplied from the select timing control circuit 19. The signal selection circuit 20 outputs the selected data to corresponding data lines for R (red), G (green), B (blue), and C (cyan).

For this purpose, the signal selection circuit 20 includes the four switching circuits SWR, SWG, SWB, and SWC corresponding to the four data lines for the R (red tone), G (a colored area selected from hues in the range of blue to yellow: green to yellow), B (blue tone), and C (another colored area selected from hues in the range of blue to yellow: blue-green to green). The select timing control circuit 19 outputs selection signals R_SEL, G_SEL, B_SEL, and C_SEL that control the switching on and off of the four switching circuits SWR, SWG, SWB, and SWC.

As described above, the command control circuit 13A outputs image data and the like to the image-processing circuit 14, the selector circuit 15, and the latch circuit 16. In addition, the command control circuit 13A outputs the amplification factor control signal (ADJ) to the amplifier 18, and outputs the selection control signal (SELL) to the select timing control circuit 19.

The command control circuit 13A supplies the amplification factor control signal (ADJ) to the amplifier 18. The amplifier 18 amplifies the input image data on the basis of the amplification factor control signal (ADJ) at an amplification factor that is different in the transmissive mode and the reflective mode. More specifically, when the display mode is the reflective mode, the command control circuit 13A supplies the amplifier 18 with the amplification factor control signal (ADJ) so as to amplify the image data at an amplification factor lower than that in the transmissive mode. In the case of the reflective display, the command control circuit 13A constitutes a control circuit in which the amplification factor of the amplifier that amplifies the image data for the reflective display is controlled to be lower than that in the case of the transmissive display.

Furthermore, the command control circuit 13A supplies the select timing control circuit 19 with the selection control signal (SELL) for selecting an output signal supplied to each data line. The select timing control circuit 19 controls each of the switching circuits of the signal selection circuit 20 on the basis of the selection control signal (SELL) so that the selection of image data that are output to the data lines for R, G, B, and C, and the selection periods of the image data are different between the transmissive mode and the reflective mode. The image data is written on a predetermined pixel of the display device according to the output of the signal selection circuit 20. The select timing control circuit 19 and the signal selection circuit 20 constitute a selective output circuit. Specifically, in the case of the reflective display, the select timing control circuit 19 and the signal selection circuit 20 select image data for the reflective display within a predetermined period to output the image data. In the case of the transmissive display, the select timing control circuit 19 and the signal selection circuit 20 selects image data for the transmissive display within a predetermined period to output the image data.

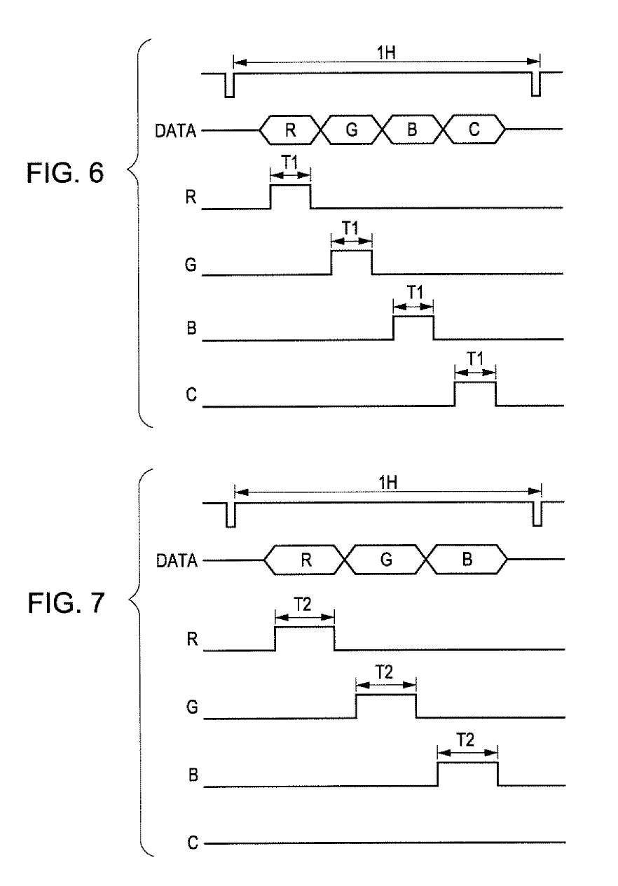

FIG. 6 is a timing chart showing selection timings of individual image data during one horizontal scanning period (hereinafter referred to as 1H period) in the transmissive mode. FIG. 7 is a timing chart showing selection timings of individual image data during the 1H period in the reflective mode.

As shown in FIG. 6, in the transmissive mode, the select timing control circuit 19 sequentially selects the switching circuit SWR for R, the switching circuit SWG for G, the switching circuit SWB for B, and the switching circuit SWC for C during a predetermined period of the 1H period and outputs the four image data. In contrast, in the reflective mode, the select timing control circuit 19 sequentially selects the switching circuit SWR for R, the switching circuit SWG for G, and the switching circuit SWB for B during the predetermined period of the 1H period and outputs the three image data.

The select timing control circuit 19 outputs the three selection signals R_SEL, G_SEL, and B_SEL for selecting individual switching circuits such that, in the 1H period, a period T2 during which each image data is selected in the reflective mode is longer than a period T1 during which each image data is selected in the transmissive mode. As shown in FIG. 7, in the reflective mode, the image data of cyan is not selected. Instead, the image data of the other three colors are selected such that the selection period T2 of the other three color signals (RGB) is longer than the selection period T1 in the transmissive mode.

The operation of the driving circuit having the above structure will now be described. The command control circuit 13A operates according to the information MODE of the input display mode. When the display mode is the transmissive mode, the command control circuit 13A supplies the image-processing circuit 14 with the clock signal (CLK) and outputs to the selector circuit 15 a selection signal (SEL) for selecting image data output from the image-processing circuit 14 and outputting the selected image data to the latch circuit 16.

The command control circuit 13A supplies the amplifier 18 with an amplification factor control signal (ADJ) for providing an amplification factor in the transmissive mode. Furthermore, during the transmissive mode, the command control circuit 13A supplies the select timing control circuit 19 with the selection control signal (SELL) so as to provide the selection timings and the selection period that are shown in FIG. 6. As a result, the select timing control circuit 19 outputs to the signal selection circuit 20 selection signals R_SEL, G_SEL, B_SEL, and C_SEL that control the switching on and off of the four switching circuits SWR, SWG, SWB, and SWC at a timing shown in FIG. 6.

In contrast, when the display mode is the reflective mode, the command control circuit 13A stops supplying the image-processing circuit 14 with the clock signal (CLK), and the process for converting from three colors to four colors is not performed. Furthermore, during the reflective mode, the command control circuit 13A outputs to the selector circuit 15 a selection signal (SEL) for selecting the image data output from the command control circuit 13A and outputting the selected image data. As a result, during the reflective mode, since the clock signal (CLK) is not input to the image-processing circuit 14, the image-processing circuit 14 is not driven, and thus electric power is not consumed.

The command control circuit 13A supplies the amplifier 18 with an amplification factor control signal (ADJ) for providing an amplification factor in the reflective mode. Furthermore, during the reflective mode, the command control circuit 13A supplies the select timing control circuit 19 with the selection control signal (SELL) so as to provide the selection timings and the selection period that are shown in FIG. 7. As a result, the select timing control circuit 19 outputs to the signal selection circuit 20 selection signals R_SEL, G_SEL, and B_SEL that control the switching on and off of the three switching circuits SWR, SWG, and SWB at a timing shown in FIG. 7.

As shown in FIG. 7, since the period T2 during which each of the three image data is selected in the reflective mode can be longer than that in the transmissive mode, the amplification factor during the reflective mode can be set to a value lower than the amplification factor during the transmissive mode. Thus, power consumption in the amplifier 18 can be reduced.

According to this embodiment, in the reflective mode, the image-processing circuit 14 is not driven, and the image data is amplified by the amplifier 18 at an amplification factor lower than that in the transmissive mode. Therefore, power consumption of the driving circuit for the liquid crystal device can be reduced.

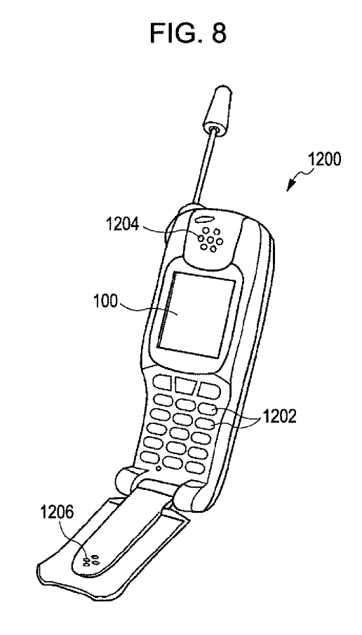

The driving circuits according to the above-described two embodiments are applied to an electronic apparatus such as a cell phone. Next, a description will be made of an electronic apparatus including the liquid crystal display device having the driving device according to one of the two embodiments as a display device. FIG. 8 is a perspective view showing a cell phone as an example of an electronic apparatus. As shown in FIG. 8, a cell phone 1200 includes a plurality of operation buttons 1202, an earpiece 1204, a mouthpiece 1206, and a display 100 in which the liquid crystal display device serving as the above electro-optical device is provided. In the liquid crystal display device including the display 100, the driving circuit according to one of the above two embodiments is used.

In the above two embodiments, the image data for the transmissive display in the transmissive mode include four colors. Alternatively, the image data may include five or more colors. In such a case, the image-processing circuit 14 performs a color conversion from three colors to five or more colors, and the select timing control circuit 19 is also controlled so as to select the color signals of the five or more colors.

The driving circuit according to the invention can be applied not only to a driving circuit for an active matrix liquid crystal display device, including for example, thin-film transistors (TFTs), but also to a driving circuit for a passive matrix liquid crystal display device or a liquid crystal display device including thin-film diodes (TFDs) as the switching elements in the same manner.

In addition to a cell phone, examples of the electronic apparatus that can include the driving circuit for an electro-optical device according to the invention include a personal digital assistant (PDA), a portable personal computer, a digital camera, a monitor for automobiles, a digital video camera, a liquid crystal television, viewfinder-type and direct-monitoring-type video tape recorders, a car navigation system, a pager, an electronic notebook, a word processor, a workstation, a video telephone, and a POS terminal.

The invention is not limited to the above-described embodiments, and various changes and modifications can be made as long as the essence of the invention is not changed.

The entire disclosure of Japanese Patent Application Nos: 2005-301254, filed Oct. 17, 2005 and 2006-124919, filed Apr. 28, 2006 are expressly incorporated by reference herein.

What is claimed is:

1. A driving circuit for an electro-optical device in which a transmissive display mode and a reflective display mode can be switched, the driving circuit comprising:
an image-processing circuit that converts image data for reflective display for the reflective display mode to image data for transmissive display for the transmissive display mode; and
a control circuit that outputs the image data for the transmissive display converted by the image-processing circuit in the transmissive display mode, and stops driving the image-processing circuit to output the image data for the reflective display in the reflective display mode.

2. The driving circuit for an electro-optical device according to claim 1, further comprising:
an amplifier that amplifies the image data for the transmissive display and the image data for the reflective display; and
a selective output circuit that selects either the image data for the reflective display or the image data for the transmissive display within a predetermined period to output the image data,
wherein, in the reflective display mode, the control circuit controls the amplification factor of the amplifier that amplifies the image data for the reflective display so as to be lower than the amplification factor in the transmissive display mode.

3. The driving circuit for an electro-optical device according to claim 1, wherein the image data for the reflective display are color signals having three hues of a red tone, a green tone, and a blue tone, and the image data for the transmissive display are color signals having four or more hues.

4. The driving circuit for an electro-optical device according to claim 3, wherein the image-processing circuit converts the image data for the reflective display of the color signals having the three hues to the image data for the transmissive display of the color signals having the tour or more hues.

5. The driving circuit for an electro-optical device according to claim 1, wherein, in the reflective display mode, the control circuit stops driving the image-processing circuit by stopping the supply of a clock signal to the image-processing circuit.

6. The driving circuit for an electro-optical device according to claim 2, wherein, in the reflective display mode, the selective output circuit selects the color signals having the three hues and dummy data to output the signals and the data.

7. The driving circuit for an electro-optical device according to claim 2, further comprising:
a select timing control circuit that controls the output of the selective output circuit,
wherein, in the transmissive display mode and the reflective display mode, the select timing control circuit controls the output of the selective output circuit so that the selection period of each image data is different for the color signals having the three hues and for the color signals having the four or more hues.

8. The driving circuit for an electro-optical device according to claim 7, wherein the select timing control circuit controls the output of the selective output circuit so that, during one horizontal scanning period, the period during which each image data is selected in the reflective display mode is longer than the period during which each image data is selected in the transmissive display mode.

9. An electronic apparatus comprising the driving circuit for an electro-optical device according to claim 1.
